(19) United States
(12) Patent Application Publication
(10) Pub. No.: US 2015/0116111 A1
(43) Pub. Date: Apr. 30, 2015

(54) Open Security System

(71) Applicant: Scott Foster, Ardmore, OK (US)

(72) Inventor: Scott Foster, Ardmore, OK (US)

(21) Appl. No.: 14/530,001

(22) Filed: Oct. 31, 2014

Related U.S. Application Data
(60) Provisional application No. 61/897,909, filed on Oct. 31, 2013.

(51) Int. Cl. G08B 21/18

(52) U.S. Cl. CPC G08B 21/18
USPC 340/517

(57) ABSTRACT

A security system using a predetermined identification characteristic of permissible occupants. Sensors detect the characteristic, such as a facial scan using facial recognition software, and cross-reference the characteristic with the predetermined characteristics. Secondary identification devices such as RFID tags and cellular phones may be used to provide access within the system to persons who are not previously identified as permissible occupants. An alarm is triggered if an occupant is in an area and not recognized by the security system or utilizing a secondary identification device.

### CROSS REFERENCE TO RELATED APPLICATION

This application claims the benefit of provisional patent application Ser. No. 61/897,909 filed on Oct. 31, 2013, the entire contents of which are incorporated herein by reference.

### FIELD

The present invention relates generally to security systems.

### SUMMARY

The present invention is directed to an open security system. The system comprises a plurality of sensors to detect an identifying characteristic such as facial recognition or an RFID indicator. The system further comprises a first computer system comprising a database containing permissible occupants for a high security area, each of the permissible occupants having a predetermined identifying characteristic and a processor adapted to receive the identifying characteristic from the plurality of sensors and compare the identifying characteristic to the predetermined identifying characteristic in the database. The processor sends an alarm signal when the identifying characteristic does not match one of the predetermined identifying characteristics stored in the database. An alarm system receives the alarm signal and provides an alarm.

### BRIEF DESCRIPTION OF THE DRAWINGS

FIG. 1 is a diagrammatic representation of the security system of the disclosed invention.

FIG. 2 is a flow chart representing the logic provided by the first computer system and security system of the disclosed invention.

### DETAILED DESCRIPTION

An embodiment of the present invention comprises a security system 8 with sensors 16 that comprise motion detectors, RFID Sensors, WIFI/Bluetooth, GPS, CCTV, Photo Electric Sensors, 3D imaging sensors, thermal sensors, ultrasonic sensors, and tracking software to locate persons or occupants by room or area. The system recognizes occupants in a given room and allow or not allow them access by facial recognition access and/or physical device (like RFID, cell phone, FOB, medical chip with Bluetooth or WIFI, or other similar device) on person for acknowledgement of access. The software and hardware will triangulate position of all movement detected and ignore or allow it. A computer system 18 will either alert or ignore subject proximity or location in given high security or low security area.

The system 8 may secure any RFID or proprietary tags/devices broadcast signal from being compromised with embedded security. The system 8 secures a given area where access is granted through an open door. Potential uses of the system are: nursing homes, hospitals, banks, department of defense, government buildings, inventory or supply rooms, casinos, schools, vault or safe deposit rooms, or any secure area, etc.

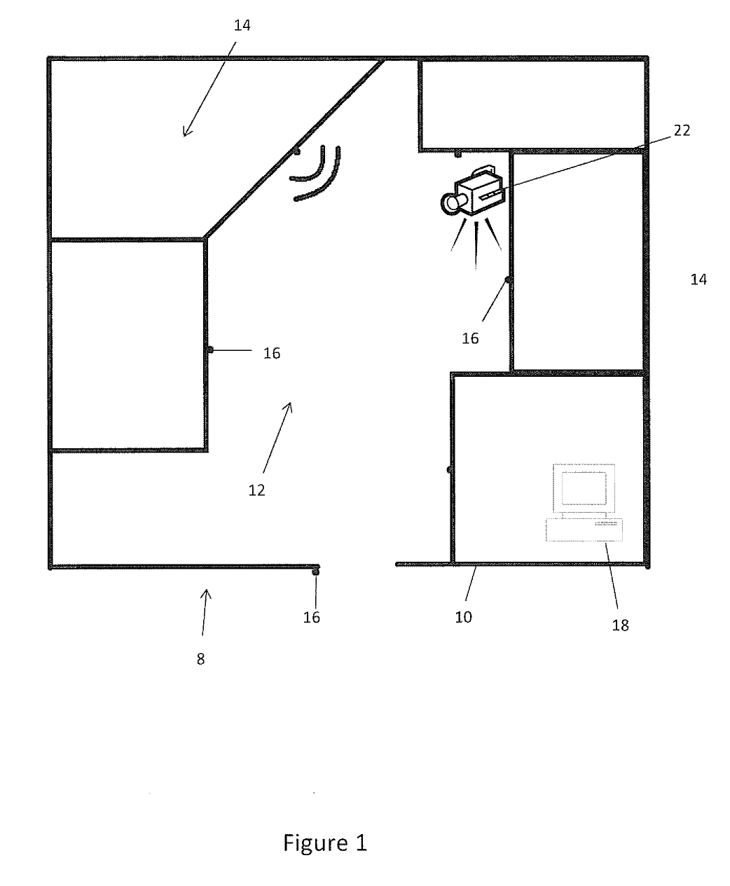

With reference now to FIG. 1, shown therein is a floorplan 10 utilizing the system of the present invention. The floor plan 10 may be any area in need of a security system, such as a nursing home, hospital floor, private home, office building, or other facility. The floorplan 10 comprises low security areas 12 and high security areas 14. Low security areas 12 for a particular facility may comprise lobbies, waiting rooms, or other similar areas. High security areas 14 may comprise records rooms, patient rooms, or other areas. The low security areas 12 and high security areas 14 each comprise an occupant sensor 16. The occupant sensor 16 may comprise a visual recorder for indicating the facial characteristics of occupants and/or an electronic sensor, such as an RFID receiver. Alternatively, the occupant sensor may comprise a heat, movement or infrared sensor to identify the presence of an occupant. The occupant sensor records an identifying characteristic (or lack thereof) for each occupant. The occupant sensor 16 sends a signal to a first computer system 18 that references the detected identifying characteristics of each occupant or notes that an occupant has no detected characteristic. The occupant sensors 16 preferably are positioned to cover entry and exit areas and windows of the high security areas 14 in one embodiment, but may be expanded to cover entry and exit/window areas and complete movement/tracking throughout the entirety of the area. Signals may be sent from the occupant sensors 16 to the computer system 18 through wireline or wirelessly.

The computer system 18 comprises a processor that receives the detected identifying characteristic and cross-references it against a pre-determined list of permissible occupants contained within a database. Permissible occupants may be identified by facial characteristics—for example—in the case of known staff, patients, nursing home residents, etc. or by RFID tag—for example—in the case of known, checked-in visitors who have received a tag. The list of permissible occupants may be different in the low security area 12 than in each high security area 14. One of skill in the art will appreciate that each high security area 14 may have a different list of permissible occupants such that a permissible occupant for one room—a family member of a patient, for example—is not allowed to enter other high security areas related to other patients or off-limits areas of a floorplan 10.

As shown in FIG. 1, the sensors 16 are located near the doors of the high security areas 14 such that the identification of an occupant can be determined by the processor 18 at the time of entry into a high security area 14. When an individual who is not a permissible occupant is detected within a high security area 14, an alarm is sounded. Depending on the particular application of the invention, the alarm may take several forms. For example, in certain areas such as staffed hospital floors, the most appropriate alarm may be an alert at a nurse's station, so that the identity of an occupant may be quickly determined. In personal homes or nursing homes (especially after hours), the alarm may be an audible noise and/or an alert to a local police department or security company.

The system also may comprise a graphical user interface that shows faces and or names of people occupying certain high security areas 14 and low security areas 12. The graphical user interface may be mounted on wall at entry of building, room, or home or may be incorporated at the processor of computer system 18. The system 8 of the present invention can therefore identify persons in said location at point of entry and/or exit for informing others as to who are present at the existing said location. The system may also comprise a secondary identification device such as bio-authentication, RFID scan or password. This may also then be used as time tracking or general security to an event or area. In the embodiment where the sensors 16 comprise a thermal or infrared scanner, the secondary identification method may be required for all occupants of a high security area 14.

The system 8 may further comprise a camera system 22. The system 8 is adapted to selectively activate the camera system 22 when an occupant enters a high security area 14, whether the occupant is a permissible occupant or not. Other defined “rules of system” are anticipated and may he configured at the computer system 18. When such rules are broken or met, alerts, such as electronic messages or text messages, alarms, signals to activate the camera system 22, lock doors in the floor plan 10, etc. can be sent as determined at the computer system 18.

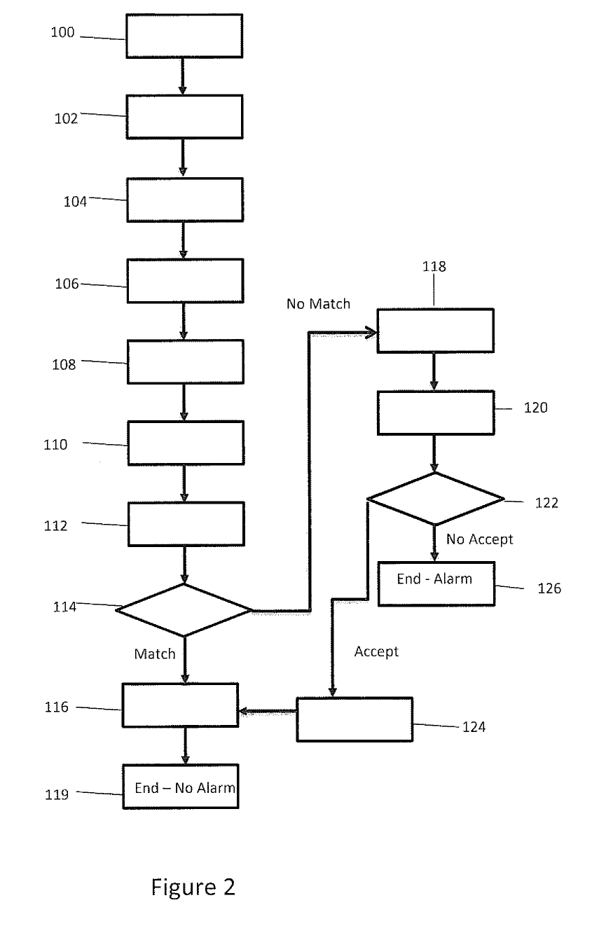

Turning now to FIG. 2, shown therein is the security system 8 of the present invention in operation. A plurality of sensors 16 are provided to a floorplan 10 at 100. A list of permissible occupants and identifying characteristics is provided to the database at 102. Optionally, at 104, a secondary identification device, such as an RFID tags, cellphone signal or password is provided to allow access to permissible occupants without stored identifying characteristics. At 106, an occupant enters the floorplan 10. The occupant is scanned by the sensor 16 at 108. The identifying characteristic of the occupant, including visual recognition, RFID tag, password, biometric characteristic, etc., is then sent to the computer system 18 at 110. The identifying characteristic is cross-referenced with the list of permissible occupants and the pre-determined identifying characteristics at 112. If there is a match at 114, the computer system 18 notes the presence of the permissible occupant at 116 and the process ends at 119.

If there is not a match, an alarm signal is sent by the processor at 118. The alarm is then activated at 120. As described above, the alarm signal activated at 120 may comprise a signal at a nurse's station, an audible alarm, or a prompt to the occupant to enter a password, RFID or Near Field scan or biometric identifier such as a fingerprint scan within a predetermined amount of time to prevent an audible alarm. Optionally, if the occupant provides an acceptable password, electronic scan or biometric identifier at 122, the alarm is disabled at 124, the computer system notes the presence of the permissible occupant at 116 and the process ends as above. If the occupant does not provide an acceptable password, electronic scan, or biometric identifier at 122, the alarm is confirmed and the process ends at 126. One of ordinary skill can appreciate that the password may be entered at a keypad, spoken audibly, or keyed in through use of a cellular device or other remote control device.

The system 8 may include battery backup, surge protection, secondary batteries, and solar power, interface for controlling/activating a smart home or business upon recognition of authorized person for starting specific electronics/equipment as related to user location in building/home. Known modules would allow system 8 to be configured or operated via WIFI/Ethernet through either a web interface or a smartphone or tablet app. The system 8 may be always on, or may be used in conjunction with other security systems.

One of ordinary skill in the art will appreciate that multiple variations may exist without departing from the spirit of the present invention. For example, rather than utilizing an RFID identifier, cell phone signals may be used to provide secondary authentication of an identity. The computer system 18 may be used to track statistics of those entering a floorplan rather than providing an alarm, for example, at a store with many low security areas, the sensors 16 and computer systems may be utilized to keep track of returning customers, etc. The sensors 16 may also be used to log employee or student attendance in a classroom or workplace without relying on other attendance verification means, such as punching a time card.

What is claimed is:

1. A security system comprising:
a plurality of sensors to detect an identifying characteristic;
a first computer system comprising:
a database containing permissible occupants for a high security area, each of the permissible occupants having a predetermined identifying characteristic; and
a processor adapted to receive the identifying characteristic from the plurality of sensors and compare the identifying characteristic to the predetermined identifying characteristic in the database;
wherein the processor sends an alarm signal when the identifying characteristic does not match one of the predetermined identifying characteristics stored in the database; and
an alarm system to receive the alarm signal and provide an alarm.

2. The system of claim 1 wherein the alarm signal is an audible alarm.

3. The system of claim 1 wherein the alarm signal comprises an alert message at a nurse's station.

4. The system of claim 1 wherein the alarm signal comprises a text message.

5. The system of claim 1 wherein the identifying characteristic comprises visual recognition.

6. The system of claim 1 wherein the identifying characteristic comprises an RFID signature.

7. The system of claim 6 wherein the biometric characteristic comprises a retinal scan.

8. The system of claim 1 further comprising a secondary identification device and a secondary sensor wherein the secondary sensor detects the secondary identification device and sends a signal to the processor when the secondary identification device is present.

9. The system of claim 8 wherein the secondary sensor and the sensor are integral.

10. The system of claim 8 wherein the processor does not compare the predetermined identifying characteristics in the database with the identifying characteristic of the occupant when the secondary sensor detects the secondary identification device.

11. The system of claim 8 wherein the secondary identification device comprises an RFID tag.

12. The system of claim 8 wherein the secondary identification device comprises a cellular phone.

13. A method for identifying an occupant of an area comprising:
establishing a database containing permissible occupants for an area, each of the permissible occupants;
storing a predetermined identifying characteristic for each of the permissible occupants;
detecting an occupant in the area;
detecting a characteristic of the occupant of the area;
transmitting the detected characteristic to a processor;
comparing the detected characteristic to the predetermined identifying characteristics of each of the permissible occupants; and
transmitting an alarm signal if the detected characteristic does not match any of the predetermined identifying characteristics.

14. The method of claim 13 further comprising detecting a secondary identification device and disabling the alarm signal if the secondary identification device is detected.

15. The method of claim 14 wherein the secondary identification device comprises a cell phone.

16. The method of claim 14 wherein the secondary identification device comprises an RFID tag.

17. The method of claim 13 further comprising deactivating the alarm signal through entry of a password.

18. The method of claim 13 wherein the characteristic comprises a facial scan.

19. The method of claim 13 further comprising storing a record of the occupants of the area.

20. The method of claim 13 further comprising activating a camera system when the occupant is detected in the area.
